(19) United States
(12) Patent Application Publication
(10) Pub. No.: US 2008/0053717 A1
(43) Pub. Date: Mar. 6, 2008

(54) Utility vehicle with multiple axle steering

(76) Inventor: Joseph C. Hurlburt, Millersville, PA (US)

Correspondence Address: CNH AMERICA LLC, INTELLECTUAL PROPERTY LAW DEPARMENT, PO BOX 1895, M.S. 641, NEW HOLLAND, PA, 17557, US

(21) Appl. No.: 11/515,609

(22) Filed: Sep. 5, 2006

(51) Int. Cl. B62D 61/10

(52) U.S. Cl. 180/24.01; 180/23

(57) ABSTRACT

A utility vehicle that has a bogey beam suspension for the front steered wheels is also provided with all wheel drive and steered rear wheels for greater maneuverability. The steering of the rear wheels is coordinated with the steering of the front wheels to have the rear wheels follow in the tracks of the front wheels, thereby avoiding the need to disable the front drive on turns.

### BACKGROUND OF THE INVENTION

This invention deals generally with off road vehicles and more specifically with all wheel drive vehicles that have both front and rear drive wheels that are also both steered.

Off road utility vehicles are becoming quite common for recreational and some occupational purposes. During some seasons of the year they are heavily advertised on television, and those commercials almost always show them taking sharp turns and cresting hills at high speeds. That is all very well for the camera, but it is not easily accomplished in the real world without careful design of the vehicle. If the suspension system of such an off road vehicle is not designed to accommodate rough terrain, it is easy to end up with one or more wheels off the ground or with very light loading on some wheels. In fact, even on level ground, the steering on some vehicles can be negatively affected by merely placing a heavy load in the cargo carrying area.

This problem has been essentially solved by a suspension structure disclosed in U.S. Pat. Nos. 6,629,699; 6,536,545; 6,557,661; and 6,601,665 by Joseph C. Hurlburt, who is also the inventor of the invention described herein. The suspension system includes a “bogey beam” which is a beam parallel to the axis of the vehicle. The bogey beam distributes the vehicle load among all the wheels of the vehicle, even when rough terrain puts individual wheels at different heights. For a four wheeled vehicle, the front axle is mounted on the forward end of the bogey beam and a suspension strut connects the rear end of the bogey beam to the frame. On a six wheel vehicle, instead of the suspension strut the middle axle is attached at the rear end of the bogey beam.

U.S. patent application Ser. No. 10/766,144 also by Hurlburt, extends the use of a bogey beam to all wheel drive vehicles, those in which the front steering wheels are also driven.

However, front wheels that are both steered and powered raise new problems. Steering angles of driven axles are limited, and vehicles with full time powered steering axles have difficulty turning sharply. Rather than having the front steering axle properly pull the vehicle around turns, a steered and driven front axle acts as if it were being braked while fighting the turn unless the speed of such steered wheels is increased. This is because the limited steering angle causes the front driven wheels to have a greater turning radius and travel much farther than the non-steered axles. This wastes power, is hard on the drive train, causes severe tire wear, and tears up turf below the tires. These problems are aggravated by sharper turns.

Since an important goal of utility vehicle is good maneuverability, the steering angle problem may be the reason that prior art utility vehicles have avoided front wheel drive. A limited number of other types of vehicles have attacked the steering angle problem. U.S. patent application Ser. No. 10/766,144 by Hurlburt, suggests automatic disengagement of the steering axle drive during tight turns, and some high end automobiles have added only limited steering to the rear wheels to counteract the problem.

It would be very beneficial to provide utility vehicles that not only include all wheel drive, but also overcome the problems caused by the limited steering angle of driven front wheels.

### SUMMARY OF THE INVENTION

The present invention solves the problem of limited front wheel steering angles on all wheel drive utility vehicles such as the vehicle disclosed in U.S. patent application Ser. No. 10/766,144 by Hurlburt, the disclosure of which is incorporated herein and made a part of this application. The limitation on maneuverability of an all wheel drive utility vehicle is overcome by adding steering to the rear wheels. With the proper selection of the rear steering angle, the drive to the rear wheels can be maintained at the same speed as the drive to the front wheels, and the turning circle diameter can even be reduced from that of a front wheel drive utility vehicle with standard steering.

In the preferred embodiment of the present invention the steering angles of the rear wheel are approximately the same as those for the front wheels resulting in an inner rear wheel maximum angle of 45 degrees and an outer rear wheel angle of 26 degrees. This results in a fully powered turning circle diameter of only 10½ feet.

The present invention provides almost identical travel paths and distances for all the axles of an all wheel drive utility vehicle and thereby allows maintaining full power in turns and improves maneuverability.

### BRIEF DESCRIPTION OF THE DRAWINGS

FIG. 1 is a perspective side view of a typical six wheel utility vehicle upon which the preferred embodiment of the invention is installed.

FIG. 2 is a bottom plan view of the frame and drive apparatus of a six wheel utility vehicle provided with the rear wheel steering of the preferred embodiment of the invention.

### DETAILED DESCRIPTION OF THE INVENTION

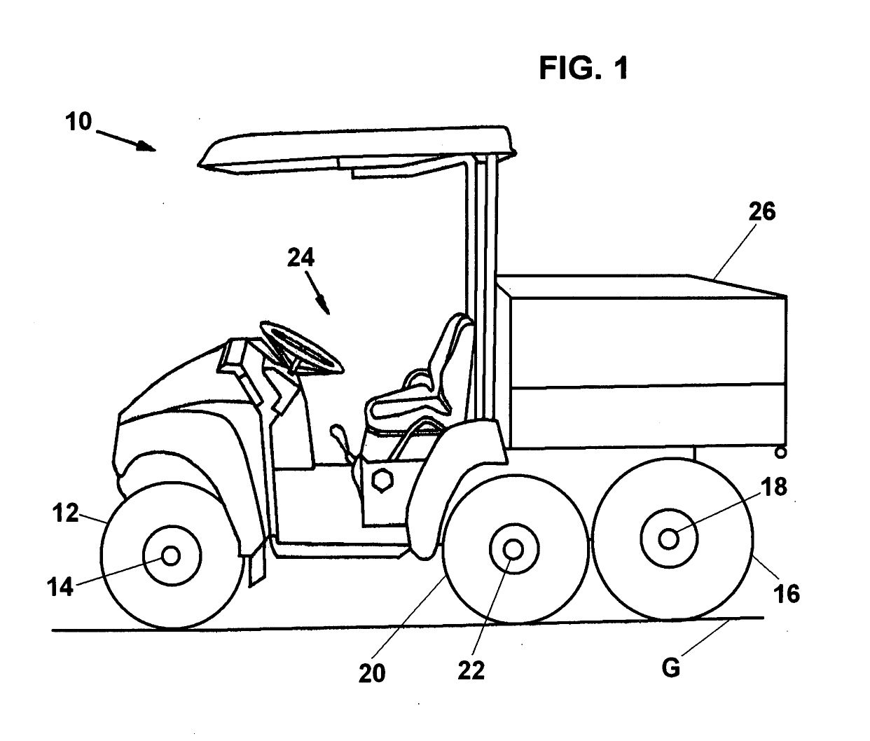

FIG. 1 is a perspective side view of a typical six wheel utility vehicle 10 upon which the preferred embodiment of the invention is installed. Vehicle 10 has all its wheels powered and it is supported above the ground G by front steered and driven wheels 12 mounted on front steering axle 14, by rear driven wheels 16 mounted on rear drive axle 18, and by middle driven wheels 20 mounted on middle axle 22. Vehicle 10 includes an operator compartment 24, with seats and the typical conventional controls, and a load bed 26 behind operator compartment 24. Except for the fact that vehicle 10 has all its wheels powered and includes rear wheel steering, which is discussed below, it is quite conventional.

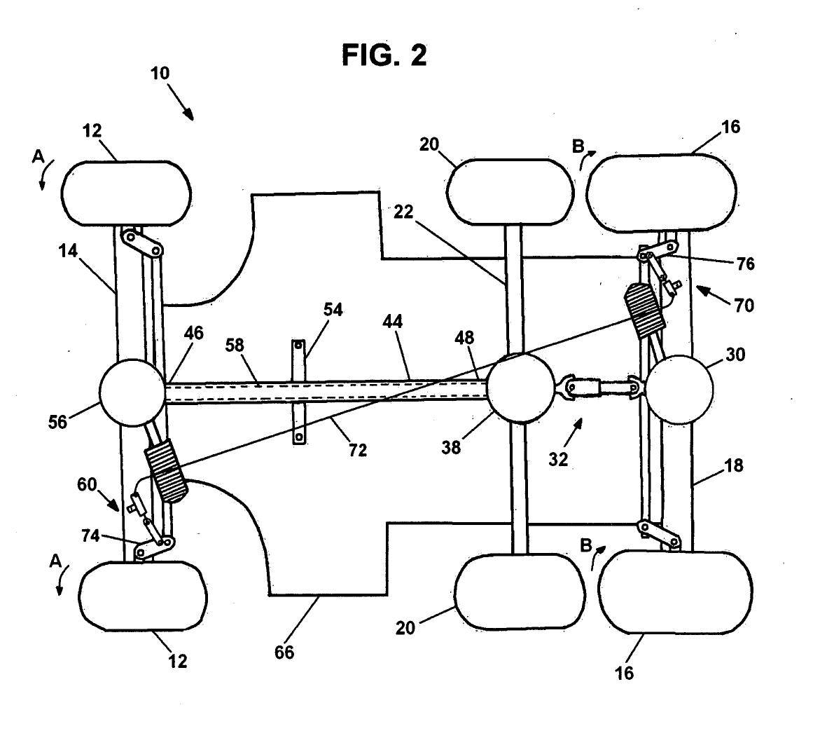

FIG. 2 is a bottom plan view of the frame and drive apparatus of six wheel utility vehicle 10 with the rear wheel steering of the preferred embodiment of the invention.

Many parts of the structure of utility vehicle 10 shown in the figures have been previously disclosed, and are more fully described in U.S. patent application Ser. No. 10/766,144 by Hurlburt. However, a brief summary of some of those previously disclosed features follows.

All the wheels of the utility vehicle 10 are powered. Power is first supplied to rear wheels 16 by an engine (not shown) through transmission 30 and rear axle 18. Transmission 30 also provides power to middle wheels 20 through universal drive assembly 32. Universal drive assembly 32 accommodates to variations in the relative positions of rear wheels 16 and middle wheels 20. As more fully described in U.S. patent application Ser. No. 10/766,144 by Hurlburt, universal drive assembly 32 comprises an assembly of telescoping shafts interconnecting universal joints attached to transmission 30 and middle wheel differential 38.

Bogey beam 44 is a suspension structure in which bogey beam 44 is a pivoting, longitudinally oriented beam parallel to the axis of the vehicle. Bogey beam 44 supports front wheel axle 14 at bogey beam forward end 46 and middle wheel axle 22 at bogey beam rear end 48. Bogey beam 44 permits predictable sharing of the frame load by front wheels 12 and middle wheels 20 while keeping all four of the front and middle wheels in contact with the ground. The load on the rear of the vehicle is conventionally applied to rear axle 18, usually by shock absorbers of conventional construction at connection points (not shown) on rear axle 18. Thus, the entire vehicle load is shared by bogey beam pivot point 54 near the front of the vehicle and connection points near the rear.

Motive power is delivered to front wheels 12 by powering middle axle 22 with universal drive assembly 32 and transferring power from middle axle 22 to the front axle 14. Middle axle 22 and middle wheel differential 38 are mounted at rear end 48 of bogey beam 44 in a pivotal relationship to bogey beam 44, and front axle 14 and front differential 56 are similarly mounted in a pivotal relationship to bogey beam 44 at its front end 46. It is therefore practical to interconnect middle differential 38 to front differential 56 with a simple drive shaft 58. As shown in FIG. 2 when bogey beam 44 is hollow, drive shaft 58 can be completely enclosed within it. However, a solid bogey beam can also be used and the drive shaft can be mounted outside of and parallel to the bogey beam.

FIG. 2 shows conventional front steering assembly 60 attached to front wheels 12. Such a steering assembly is of conventional construction for steered and driven front wheels as is well known in the automotive art. FIG. 2 also shows a typical outline for frame 66 of such a vehicle.

It is at rear wheels 16 that the present invention deviates from previously disclosed utility vehicles. As shown in FIG. 2, rear wheels 16 are furnished with fully operating rear steering assembly 70. Rear steering assembly 70 is of conventional construction, but is controlled to operate in conjunction with front steering assembly 60. Since the goal of the dual steering of the front and rear wheels is to have the rear wheels follow in the tracks of the front wheels, rear wheels 16 actually steer at angles opposite to that of front wheels 12. Arrows A at front wheels 12 and arrows B at rear wheels 16 show the direction of the steering angles for a typical turn. Furthermore, to have rear wheels 16 follow in the tracks of front wheels 12, the steering angles of the two sets of wheels should also be approximately equal for any turn.

This coordinated control can be accomplished by cable 72 or a linkage (not shown). Cable 72 is perhaps the simplest of many devices that can coordinate rear steering assembly 70 with front steering assembly 60. Cable 72 is connected to front axle steering arm 74 on one side of front steering assembly 60 and connected 2 to rear axle steering arm 76 on the opposite side of rear steering assembly 70. Thus, steering the front axle in any direction results in the rear wheels steering in the opposite direction. Cable 72 is typically a sheathed cable so that it can push as well as pull rear steering arm 76 to perform its full function.

The present invention can also be used on a four wheel vehicle with a bogey beam. Such a vehicle is more fully described in U.S. patent application Ser. No. 10/766,144 by Hurlburt, and actually eliminates middle wheels 20, so that the steering of rear wheels 16 is not affected.

The present invention thereby overcomes the limitations of limited front wheel steering angles on all wheel drive utility vehicles by placing both the driven front wheels and the driven rear wheels on the same turning circle.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

What is claimed as new and for which Letters patent of the United States are desired to be secured is:

1. In a utility vehicle having a frame supported by a front steering axle with a pair of front steered wheels mounted upon the front steering axle, a rear drive axle with a pair of powered rear wheels mounted upon the rear drive axle, a middle driven axle with a pair of driven middle wheels mounted on the middle driven axle, and a longitudinally oriented bogey beam with the front steering axle attached at the front end of the bogey beam and the middle driven axle attached at the rear end of the bogey beam, the bogey beam attached to the vehicle at and pivoting about a pivot point between the front steering axle and the middle driven axle, and a drive shaft interconnecting the front steered wheels with the middle driven axle and driving the front steered wheels from the middle driven axle, the improvement comprising: the rear wheels including a steering apparatus that coordinates the steered rear wheels with the steered front wheels.

2. The vehicle of claim 1 wherein the steered rear wheels are controlled to follow in the tracks of the steered front wheels.

3. The vehicle of claim 1 further including a drive assembly interconnecting the rear drive axle to the middle driven axle to transfer power from the rear drive axle to the middle driven axle.

4. The vehicle of claim 1 further including a universal drive assembly interconnecting the rear drive axle to the middle driven axle to transfer power from the rear drive axle to the middle driven axle, wherein the universal drive assembly comprises a universal joint connected to each of the middle driven axle and the rear drive axle and an assembly with telescoping shafts interconnecting the two universal joints.

5. A utility vehicle comprising:
a frame;
a front steering axle with a pair of front steered and driven wheels mounted upon the front steering axle;
a rear drive axle with a pair of driven rear wheels mounted upon the rear drive axle;
a middle driven axle with a pair of driven middle wheels mounted on the middle driven axle;
a longitudinally oriented bogey beam with the front steering axle attached at the front end of the bogey beam and the middle driven axle attached at the rear end of the bogey beam, and the bogey beam attached to the vehicle at and pivoting about a pivot point between the front steering axle and the middle driven axle;
a drive shaft interconnecting the front steered wheels with the middle driven axle and driving the front steered wheels from the middle driven axle; and
the rear wheels including a steering apparatus that coordinates the steered rear wheels with the steered front wheels.

6. The vehicle of claim 5 wherein the steered rear wheels are controlled to follow in the tracks of the steered front wheels.

7. The vehicle of claim 5 further including a drive assembly interconnecting the rear drive axle to the middle driven axle to transfer power from the rear drive axle to the middle driven axle.

8. The vehicle of claim 5 further including a universal drive assembly interconnecting the rear drive axle to the middle driven axle to transfer power from the rear drive axle to the middle driven axle, wherein the universal drive assembly comprises a universal joint connected to each of the middle driven axle and the rear drive axle and an assembly with telescoping shafts interconnecting the two universal joints.

9. In a utility vehicle having a frame supported by a front steering axle with a pair of front steered wheels mounted upon the front steering axle, a rear drive axle with a pair of driven rear wheels mounted upon the rear drive axle, and a longitudinally oriented bogey beam with the front steering axle attached at the front end of the bogey beam and a resilient member attached at the rear end of the bogey beam and to the vehicle frame, with the bogey beam also attached to the vehicle at and pivoting about a pivot point between the front steering axle and the resilient member, and a drive shaft interconnecting the front steered wheels and the rear drive axle, the improvement comprising: the rear wheels including a steering apparatus that coordinates the steered rear wheels with the steered front wheels.

10. The vehicle of claim 9 wherein the steered rear wheels are controlled to follow in the tracks of the steered front wheels.

11. The vehicle of claim 9 wherein the resilient member is a suspension strut.

12. The vehicle of claim 9 further including a drive assembly interconnecting the rear drive axle to the drive shaft to transfer power from the rear drive axle to the front steering axle.

13. The vehicle of claim 9 further including a universal drive assembly interconnecting the rear drive axle to the drive shaft to transfer power from the rear drive axle to the front steering axle, wherein the universal drive assembly comprises a universal joint connected to each of the drive shaft and the rear drive axle and an assembly with telescoping shafts interconnecting the two universal joints.

14. A utility vehicle comprising:
a frame;
a front steering axle with a pair of front steered and driven wheels mounted upon the front steering axle;
a rear drive axle with a pair of driven rear wheels mounted upon the rear drive axle;
a longitudinally oriented bogey beam with the front steering axle attached at the front end of the bogey beam and a resilient member attached to the vehicle and to the bogey beam at the rear end of the bogey beam, with the bogey beam attached to the vehicle at and pivoting about a pivot point between the front steering axle and the resilient member;
a drive shaft interconnecting the front steered wheels and the rear drive axle and driving the front steered wheels from the rear drive axle;
and the rear wheels including a steering apparatus that coordinates the steered rear wheels with the steered front wheels.

15. The vehicle of claim 14 wherein the steered rear wheels are controlled to follow in the tracks of the steered front wheels.

16. The vehicle of claim 14 wherein the resilient member is a suspension strut.

17. The vehicle of claim 14 further including a drive assembly interconnecting the rear drive axle to the drive shaft to transfer power from the rear drive axle to the front steering axle.

18. The vehicle of claim 14 further including a universal drive assembly interconnecting the rear drive axle to the drive shaft to transfer power from the rear drive axle to the front steering axle, wherein the universal drive assembly comprises a universal joint connected to each of the drive shaft and the rear drive axle and an assembly with telescoping shafts interconnecting the two universal joints.
